(19) United States
(12) Patent Application Publication
(10) Pub. No.: US 2014/0102956 A1
(43) Pub. Date: Apr. 17, 2014

(54) COLANDER

(71) Applicants: Wade Antoine Powell, Lexington, KY (US); Geoffrey Kirk Carlson, Lexington, KY (US)

(72) Inventors: Wade Antoine Powell, Lexington, KY (US); Geoffrey Kirk Carlson, Lexington, KY (US)

(73) Assignee: CORNERSTONE INNOVATIONS, LLC, Lexington, KY (US)

(21) Appl. No.: 13/651,407

(22) Filed: Oct. 13, 2012

(51) Int. Cl. A47J 43/24

(52) U.S. Cl. CPC A47J 43/24
USPC 210/85; 210/497.01; 210/470

(57) ABSTRACT

A colander (110) is provided that can be suspended on two adjacent and substantially orthogonal edges of a rim of a substantially rectangular sink to be used hands-free. The colander is suspended by two mounting flanges (112). The colander includes a base (114), sidewalls (116) that form a substantially triangular shape, and a lateral rim (118). The base includes perforations (120) for straining of liquids and three or more feet (122) for resting the colander stably on a horizontal surface. The lateral rim may contain the mounting flanges and one or more handles (126). Inner faces of the sidewalls of the colander and handle openings (128) in the handles include serving indicators (132) such that dry pasta noodles of varying types and dry spaghetti noodles, respectively, can be measured previous to being cooked/boiled.

### BACKGROUND OF THE INVENTION

1. Field of the Invention

This invention relates to colanders, and more particularly relates to colanders that are used in kitchen sinks to strain and/or rinse solid foods such as pastas, fruits, vegetables, and the like. The invention is particularly suitable for individuals desiring to pour the solid foods that are to be strained in a hands-free mode or desiring to rinse solid foods in a hands-free mode. The invention is also suitable for individuals desiring to measure a suitable volume of solid foods to be cooked or otherwise used in a recipe or for a meal.

2. Discussion of Related Art

The use of colanders, or strainers, for such purposes as rinsing contaminants from fruit, vegetables and the like, and for draining water and other liquids from pastas and other foods after cooking is well known. Typically, the known colanders have a structure which allows suspending the contents above the basin of a sink into which the rinse water or other liquid is to be drained to facilitate disposal of the liquid and prevent contamination of the contents. For instance, the colander can include a base which rests on the bottom of the sink basin.

As another example, the colander or strainer can be of sufficient extent in at least one direction such that opposite ends thereof can rest on opposite rim or edge portions of the sink for suspending a bowl portion of the colander in or over the basin. Some colanders of this type include those that have handles, or similar features, that slide or otherwise extend from the colander to increase the effective length of the colander such that it can be suspended on opposite rim or edge portions of the sink.

In a third example, the colander contains a hook that is engaged around a faucet or a hook that is engaged over the sink rim. Colanders of this type are cantilevered from the edge of the sink rim over the basin of the sink and are not intended to touch the bottom of the sink basin.

In a final example, the colander includes an extended handle. Colanders of this type are intended to be held in one hand while pouring in a hot mixture of cooked food and water, or while rinsing food items with clean water. The extended handle allows a user to hold the colander at a greater distance from hot, scalding mixtures of cooked food and water.

There are several shortcomings with known colanders. For example, if a colander that includes a base is placed in a contaminated sink basin, then onto a countertop, tabletop, or the like, the contaminant can be transferred to the countertop or tabletop. Furthermore, at the time that a colander is to be used, it is very likely that the sink is not empty and clear of dishes or other contents. One would then be required to either empty the sink, or set the colander on the dishes or other contents. When colanders are placed on top of dishes, kitchen utensils, or the like, they become unstable and can easily shift or tip over and spill their contents into the sink basin. The unhygienic sink contents are also in such close proximity to the colander contents that contaminants can easily transfer through the perforations in the colander to the food.

An important shortcoming of known colanders of the second type is their ability to fit kitchen sinks of various sizes. Handles, or similar features, that slide or otherwise extend from the colander improve the likelihood that these colanders will fit a variety of kitchen sink sizes. However, when handles, or similar features, are extended to suspend on opposite rim or edge portions of large sinks, the handles may be subjected to excessive stress levels depending upon the weight of the contents in the colander, which can lead to permanent deformation or damage of the colander. Multiple components and moving parts can lead to higher costs as well. In addition, moving parts on colanders provide small spaces that are very difficult to clean and provide places for microbes, and the like, to grow.

A shortcoming of known colanders of the third type is that the hook used to engage around a faucet or to engage over the sink rim is generally formed at one specific size or dimension. The specific size of the hook may fit well on a certain subset of faucets or sink rims, but does not adequately fit other faucet sizes or sink rim sizes. Depending upon the specific dimensions of the colander and the sink, it is likely that the colander will not work at all, or it may lean or droop at an angle. The hooks provide a way to keep the colander off of the bottom of the sink basin, but do not provide stability for the colander, especially when it is filled with food products. As the colander is filled with food, the cantilevered weight produces undue stress on the faucet and the colander, which can cause damage to both.

A shortcoming of known colanders of the final type is the need to pour a hot mixture of cooked food with one hand while holding the colander by the handle with the other hand. When hot contents are poured into colanders, one must take care not to become scalded or burned, and should keep hands clear of the hot contents. This requirement is difficult to meet when the colander must be held in one hand. Colanders with extended handles are also inherently less stable and when the bowl portion of the colander is loaded, the colander can easily roll about the axis of the extended handle and spill its contents.

There are no known colanders that provide the capability to measure serving sizes for dry pasta noodles of various types, thus aiding in the task of preparing and cooking pasta for a recipe or meal.

The aforementioned types of colanders do not adequately meet the needs of the users of such devices and all have several shortcomings. Therefore, it would be advantageous to have a colander that provided serving size indicators, or markings, that would allow the end user to measure in dry form their desired number of recommended adult serving sizes of various types of pasta noodles. It would also be advantageous to have a colander that could be placed in a kitchen sink without contacting the bottom of the sink basin, and that functions properly and robustly in the kitchen sink independent of varying sink or faucet dimensions.

### SUMMARY OF THE INVENTION

In accordance with the present invention, a colander is provided that can be suspended on two adjacent and substantially orthogonal edges of a rim of a substantially rectangular sink to be used hands-free. The colander is suspended by two mounting flanges that prevent the colander from contacting the bottom of a sink basin. The colander includes a base, sidewalls that form a substantially triangular shape, and a lateral rim. The base includes perforations for straining of liquids and three or more feet for resting the colander stably on a horizontal surface. The lateral rim may contain the mounting flanges and one or more handles. The colander can be used hands-free.

Inner faces of the sidewalls of the colander include serving indicators such that dry pasta noodles of varying types can be measured previous to being cooked/boiled. The handle includes serving indicators such that dry spaghetti noodles, or the like, can be measured previous to being cooked/boiled.

These and other advantages of one or more aspects will become apparent from a consideration of the ensuing description and accompanying drawings. It is expressly understood, however, that the drawings are for the purpose of illustration and description only, and are not intended as a definition of the limits of the invention.

### BRIEF DESCRIPTION OF THE DRAWINGS

The accompanying drawings illustrate the present invention. In such drawings:

FIG. 1 is an upper perspective view of a colander in keeping with the present invention.

FIG. 2 is another upper perspective view of a colander in keeping with the present invention.

FIG. 3 is a top view of a colander in keeping with the present invention.

FIG. 4 is a lower perspective view of a colander in keeping with the present invention.

FIG. 5 is a detailed perspective view of a long inner sidewall of a colander in keeping with the present invention.

FIG. 6 is a detailed perspective view of a short inner sidewall of a colander in keeping with the present invention.

FIG. 7 is a detailed perspective view of another short inner sidewall of a colander in keeping with the present invention.

FIG. 8 is a detailed top view of a handle of a colander in keeping with the present invention.

### DETAILED DESCRIPTION OF PRESENTLY PREFERRED EMBODIMENT

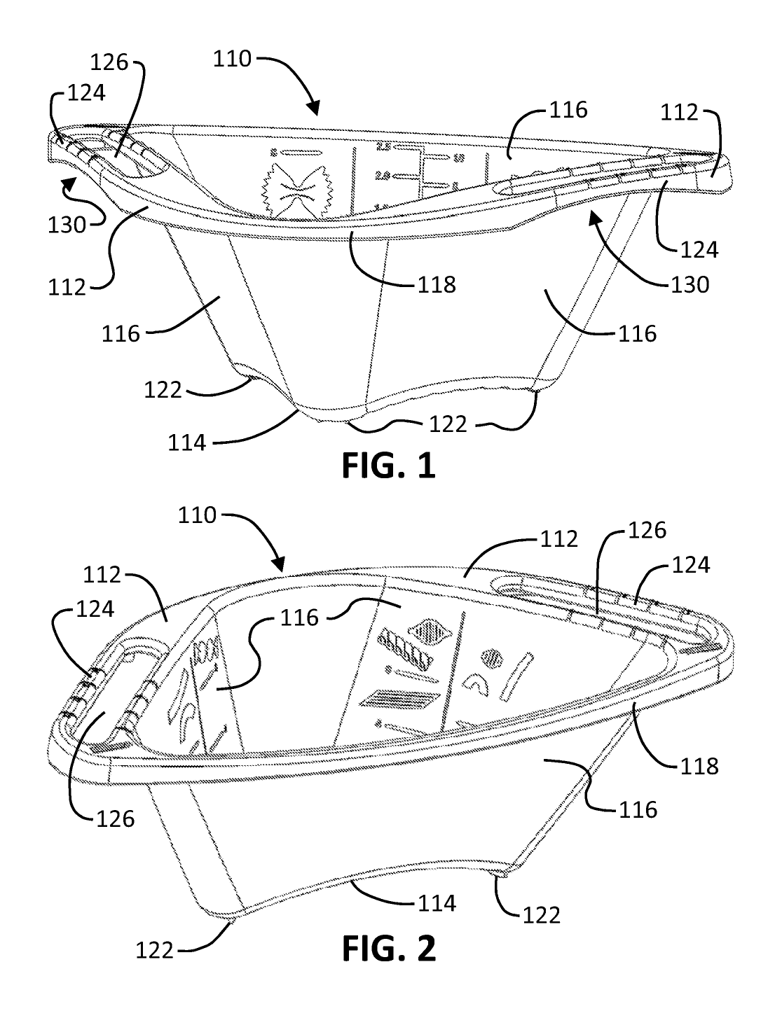

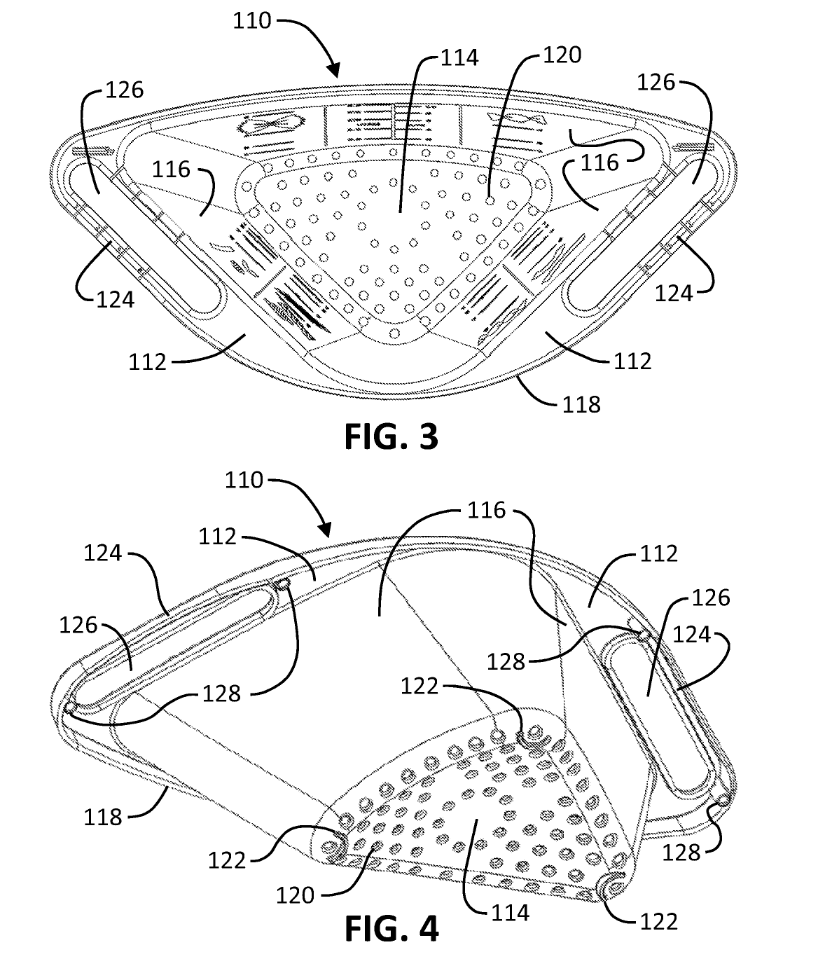

FIGS. 1 and 2 are upper perspective views and FIG. 3 is a top view of a strainer or colander 110 that can be suspended on two adjacent and substantially orthogonal, or perpendicular, edges of a rim of a substantially rectangular sink to be used hands-free. The colander 110 can be suspended by two supports, projected shelves, or mounting flanges 112 that prevent the colander from contacting the bottom of a sink basin. The colander 110 includes a floor or base 114 located at the bottom of the colander 110, sidewalls 116 that form a substantially triangular shape, and a frame or lateral rim 118 that extends completely around the top of the colander 110. The base 114 includes a plurality of holes, apertures, orifices, or perforations 120 for straining of liquids and three or more base supports, legs, or feet 122 for resting the colander 110 stably on a horizontal surface. The feet 122 may take the form of specific protrusions from the base 114, or may be three or more points or areas on the base 114 itself without any protrusions. The lateral rim 118 contains the mounting flanges 112, two grips or handles 124, and two oblong holes or handle openings 126. The finger openings or finger reliefs 130 are located adjacent each handle opening 126 and facilitate easy access of the fingers of the user to the handles 124 when resting on a flat countertop or sink rim.

FIG. 4 is a lower perspective view of the colander 110 that includes four bumpers, stabilizers, or pads 128 that attach to the underside of the mounting flanges 112 or the lateral rim 118. The colander 110 may contain one or more pads 128, or none at all. The pads 128 provide greater frictional forces between the colander 110 and the rim of the sink or the countertop surface, which results in improved stability.

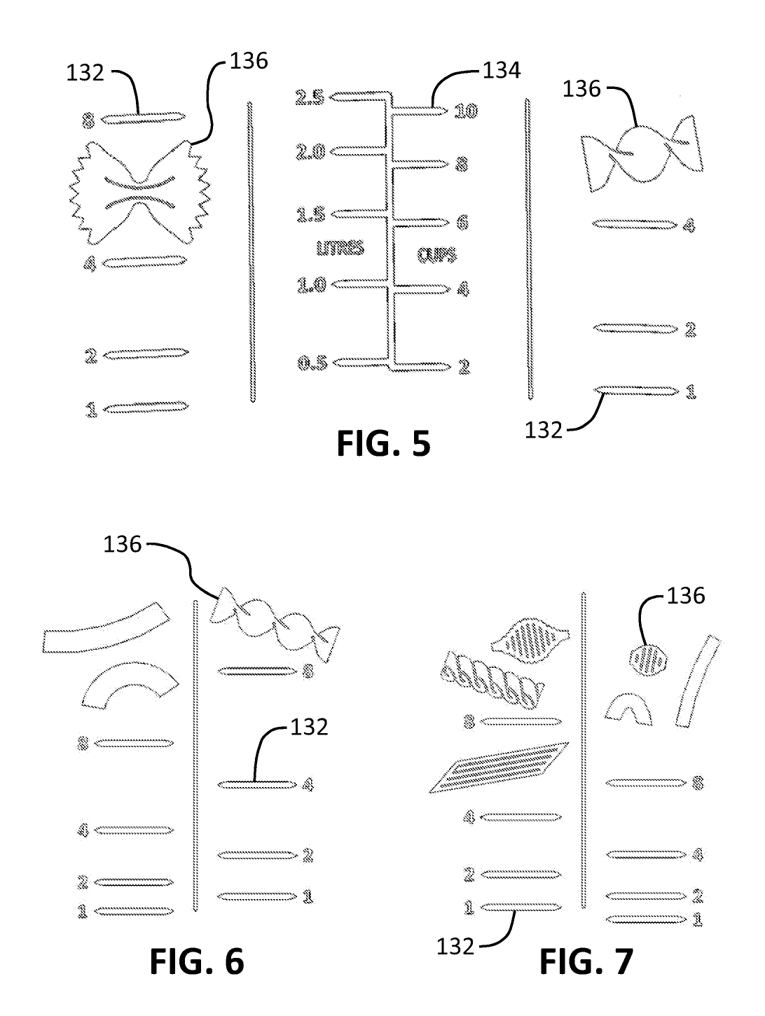

FIGS. 5, 6, and 7 are detailed perspective views of the inner surface of the sidewalls 116 of the colander 110. The sidewalls 116 include one or more serving gauges, serving markers, serving guides, serving lines, serving scales, or serving indicators 132, one or more volume gauges, volume markers, volume guides, volume lines, volume scales, or volume indicators 134, and icons, figures, representations, or symbols 136.

FIGS. 6, and 7 show a one-serving indicator, a two-serving indicator, a four-serving indicator, and an eight-serving indicator for four sets of pasta noodle types. Each serving indicator 132 is labeled with a corresponding number. The serving indicators 132 may be labeled with numbers, roman numerals, dots, or any other identifier, or left unlabeled. FIG. 6 shows three pasta noodle types. Ziti noodles and Large Elbow noodles are shown on the left side of FIG. 6. Medium Egg Noodles are shown on the right side of FIG. 6. FIG. 7 shows six pasta noodle types. Medium Shell noodles, Rotini noodles, and Penne Rigate noodles (also known as Mostaccioli noodles) are shown on the left side of FIG. 7. Small Shell noodles, Elbow noodles, and Macaroni Style noodles are shown on the right side of FIG. 7.

FIG. 5 shows a one-serving indicator, a two-serving indicator, and a four-serving indicator for two pasta noodle types, and an eight-serving indicator for one of those pasta noodle types. Each serving indicator 132 is labeled with a corresponding number. The serving indicators 132 may be labeled with numbers, roman numerals, dots, or any other identifier, or left unlabeled. FIG. 5 shows two pasta noodle types. Bowtie noodles (also known as Farfalle noodles) are shown on the left side of FIG. 5. Extra Wide Egg Noodles are shown on the right side of FIG. 5. Volume indicators 134 are shown in the middle of FIG. 5, and indicate multiple volume levels in metric (0.5, 1.0, 1.5, 2.0, and 2.5 litres) and English units (2, 4, 6, 8, and 10 cups).

The serving indicators 132 of a presently preferred embodiment represent a correlated volume to a recommended adult serving size of dry pasta weighing two ounces. Depending on the pasta noodle shape and size, the volume of dry noodles that equals two ounces will vary. The following table lists several pasta noodle types with their corresponding recommended adult serving volume of dry pasta:

| Pasta Noodle Type | One Adult Serving Size | |
|---|---|---|
| Elbow, Macaroni Style, Small Shells | ½ | cup |
| Large Elbow, Ziti | ⅔ | cup |
| Penne Rigate/Mostaccioli, | ¾ | cup |
| Medium Shells, Rotini | | |
| Medium Egg Noodles | 1 | cup |
| Bowtie/Farfalle | 1¼ | cups |
| Extra Wide Egg Noodles | 1½ | cups |

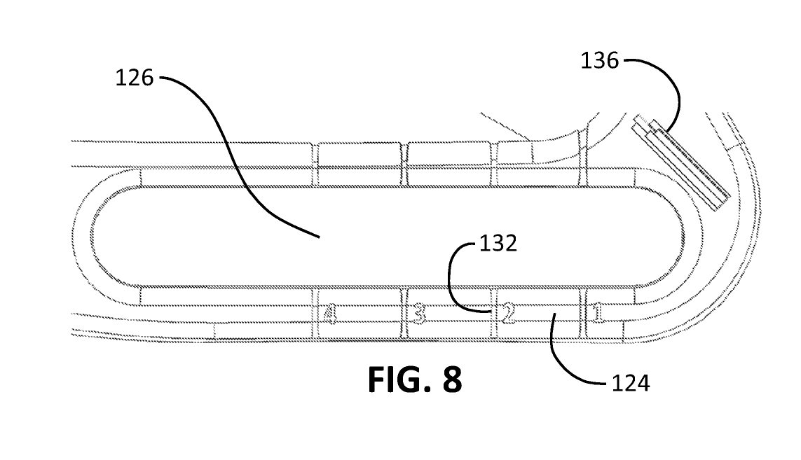

FIG. 8 is a detailed top view of the handle 124 of the colander 110. Four serving indicators 132 are included on both sides of the handle opening 126. Each serving indicator is labeled with a corresponding number. A symbol 136 is included adjacent to the handle opening 126 on a mounting flange 112. The symbol 136 adjacent to the handle opening 126 represents Spaghetti noodles.

When using the colander 110 for measuring dry spaghetti noodles prior to cooking/boiling, the user grips an unspecified amount of standard-length spaghetti noodles and inserts the cluster of noodles into the handle opening 126. The user then slides the cluster of spaghetti noodles tightly into the end of the handle opening 126 closest to the first serving indicator 132. The user compares the cluster of dry spaghetti noodles to the serving indicators 132 to determine the number of servings of dry spaghetti noodles in the cluster. The user may add or remove spaghetti noodles to bring the cluster size to the desired number of servings. Once measured, the user removes the noodles from the handle opening 126 and proceeds to cook the noodles in a separate pot, pan, or the like.

When using the colander 110 for measuring other dry pasta noodles of various types prior to cooking/boiling, the user selects a specific noodle type and matches it to the symbol 136 most like it on the inner surface of one of the sidewalls 116. The user then dispenses dry pasta noodles of the specific noodle type into the colander 110 until the level of the dry pasta noodles reaches the desired serving indicator 132. If the desired number of servings is not represented on the sidewall 116 of the colander 110, the user interpolates between the appropriate serving indicators 132, or makes multiple measurements to reach the total desired number of servings. Once measured, the user pours the noodles from the colander 110, using one of the three rounded internal corners that function to funnel the pasta noodles into a separate pot, pan, or the like, to be used for cooking.

When using the colander 110 for straining cooked pasta noodles or other hot mixtures of cooked food, the user places the colander 110 into any corner of a substantially rectangular sink. The colander 110 is suspended above the bottom of the sink basin by two mounting flanges 112, which support the colander 110 on two adjacent and substantially orthogonal edges of the rim of the sink or edges of the countertop. The two adjacent edges may or may not be at the same elevation. After placing the colander 110 in a corner of a sink, the user may dispense the hot, or cold, mixture of cooked, or uncooked, foods into the colander from any desired or preferred angle, thus avoiding any undesired results including being scalded by splashing hot liquids, being burned by hot steam, spilling some or all of the food, etc. The liquids and any other contents small enough to fit through the perforations 120 flow out of the colander 110 and into the sink. The user then lifts the colander 110 by one or more handles 124 and may shake the colander 110 to expel any additional liquids or small contents that remain. The finger reliefs 130 facilitate easy access of the fingers of the user to the handles 124 when resting on a flat countertop or sink rim. Once strained, the user pours the contents from the colander 110, using one of the three rounded internal corners that function to funnel the contents into a separate bowl, serving dish, or the like to be used for further preparation or for presenting the food for a meal. The colander 110 can then be cleaned or washed, and then stored. The colander 110 can be hung on a hook through a handle opening 126, or can stand on a relatively flat and horizontal surface on three or more feet 122 or on three or more points or areas of the base 114 of the colander 110.

When using the colander 110 for rinsing or cleaning solid foods, the user similarly places the colander 110 in the desired corner of a sink. The user may add solid foods to the colander 110 before or after placing the colander 110 in a corner of the sink. The user then rinses the contents by any preferred means including, but not limited to, using a sink faucet, using a sprayer, or pouring water from another container. The user may then follow any steps described above to complete their process.

The colander 110 is injection molded from plastic material. Those of ordinary skill in the art will recognize, however, that alternative materials and methods of manufacture could also be used, such as plastics that are thermoformed, or vacuum-formed, from extruded plastic sheet material, sheet metals that are punched and extruded, ceramics that are glazed and fired, etc. The pads 128, if they are used, are molded from a polyurethane material, and are held in place with pressure sensitive adhesive. Those of ordinary skill in the art will recognize, however, that alternative materials, methods of manufacture, and methods of attachment could also be used for the pads 128, such as other high-friction materials, interference or friction fit attachment methods, etc. The description of the current preferred embodiment should not be construed to limit the scope of the invention to any one particular material or method of manufacture. Rather, the scope of the invention should be considered only in reference to the claims, and should include alternative structures, materials, and elements that would be known to those of ordinary skill in the art.

Furthermore, the colander 110 allows users to quickly and accurately measure the amount of pasta that they desire to prepare for a meal. The user does not need to weigh their dry pasta in advance, or calculate the recommended volume for one or more servings and then use a separate volume measuring tool. The user can simply match the pasta noodle type to the closest matching symbol 136, and then fill the colander 110 to the serving indicator 132 that matches their desired number of servings. When the user is ready to strain or rinse items of food, there is no need to clear the sink of its dirty contents, since the colander 110 can be placed in any corner of the sink and suspended over existing sink contents. As a result, valuable time is saved at this stage of the process and throughout the user's food preparation process. Since the colander 110 is suspended over the bottom of the sink basin, it does not come into contact with other dirty dishes, utensils, or the like, and prevents contaminants from contacting the colander 110 or the food which it holds. Because the colander 110 rests on the flat and horizontal countertop or sink rim surface, the colander 110 is more stable and, by virtue of the orthogonal mounting flanges 112, the colander 110 is not prone to tipping or sliding. The colander 110 is not dependent upon specific ranges of sink or faucet dimensions or designs in order to function properly, and therefore is able to function in almost any substantially rectangular kitchen sink. Since the colander 110 is stable when placed in the corner of a sink, it can be used hands-free, which allows the user to avoid being burned by any hot mixtures of cooked food and to operate in a safer mode. The hands-free nature of the design of the colander 110 inherently reduces messes because the user has better control when using both hands to pour the items of food into the colander. Because the colander 110 sits in the corner of the sink and is placed adjacent to two sides/edges of the sink, the colander 110 is very sturdy and is able to hold a considerable amount of weight without any adverse consequences, such as permanent deformation or yielding of the material of the colander 110. The substantially triangular shape of the colander 110 aids in funneling the contents when the user pours the contents out of the colander 110, which reduces spills and messes that are typical of prior art colanders when their contents are transferred to a separate bowl, serving dish, or the like. Because the colander 110 in the preferred embodiment contains no moving parts, the colander 110 is easy to clean, and its design prevents the likelihood of germs contacting and/or growing on the colander.

While the above description contains many specificities, these should not be construed as limitations on the scope, but rather as an exemplification of several embodiments thereof. Many other variations are possible. For example, the lateral rim 118 and the mounting flanges 112 may be contained in separate features on the colander 110. The colander 110 can be formed in alternative shapes, including shapes that are substantially circular, oval, square, rectangular, etc., so long as the mounting flanges 112 are extensive enough to prevent the colander 110 from tipping over when placed on two adjacent and substantially orthogonal edges of the rim of the sink. The colander 110 can be scaled to different sizes and the essential elements of the colander 110 can be adjusted to fit sinks of larger or smaller sizes. The colander 110 can be provided in a variety of colors or patterns, or in various degrees of transparency or opacity. The handles 124 of the colander 110 can be formed in a variety of shapes and/or sizes, or can be formed in different positions, or areas, of the colander 110, such as being formed in the sidewalls 116 of the colander 110. More or fewer serving indicators 132 can be included, and more of fewer pasta types can have accompanying symbols 136 and serving indicators 132. Symbols 136 may be used for other types of foods, or words in one or more languages may be used to represent an item of food or otherwise communicate the purpose of any serving indicator 132.

Accordingly, the scope should be determined not by the embodiments illustrated, but by the appended claims and their legal equivalents.

What is claimed is:

1. A colander having one or more perforations for the purpose of straining, comprising:
a. a base at the bottom of said colander,
b. one or more sidewalls extending upwardly from said base, and
c. one or more mounting flanges extending outwardly from said sidewalls in at least two directions which are substantially perpendicular to one another,
whereby said colander can be placed in a corner of a substantially rectangular sink and can be suspended over the bottom of said sink by said mounting flanges resting on two adjacent and substantially perpendicular edges of said corner of said sink.

2. The colander of claim 1, further comprising a lateral rim that extends around the top of said colander.

3. The colander of claim 1, further comprising one or more feet for resting said colander stably on a horizontal surface.

4. The colander of claim 1, further comprising one or more pads attached to the underside of said mounting flanges, wherein said pads provide greater frictional forces between said colander and the rim of said sink.

5. The colander of claim 1, further comprising one or more handles.

6. The colander of claim 5, further comprising handle openings of predetermined size and shape located in said mounting flanges and one or more serving indicators located adjacent to said handle openings, wherein a number of servings of dry spaghetti noodles can be measured.

7. The colander of claim 1, further comprising one or more finger reliefs located at the outer edge of said mounting flanges, wherein said finger reliefs provide access for fingers of a user between said mounting flanges and a rim of said sink.

8. The colander of claim 1, wherein the number of said side walls equals three and the shape of said colander is substantially triangular.

9. The colander of claim 8, wherein said shape of said colander is approximately a right triangle.

10. A colander having one or more perforations for the purpose of straining, comprising:
a. a base at the bottom of said container,
b. one or more sidewalls extending upwardly from said base, and
c. one or more serving indicators located on said sidewalls signifying suggested serving sizes of a specific item of food,
whereby said colander allows for measurement of a number of servings of said item of food.

11. The colander of claim 10, further comprising one or more volume indicators located on said sidewalls, so that the amount of the contents of said colander can be measured while remaining in said colander.

12. The colander of claim 10, further comprising one or more symbols located in close proximity to a set of said serving indicators.

13. The colander of claim 12, wherein said symbols are words or pictorial icons.

14. The colander of claim 12, wherein said symbols represent one or more pasta noodles and said serving indicators refer to suggested serving sizes of said pasta noodles in their dry form.

15. A colander having one or more perforations for the purpose of straining, comprising:
a. mounting means for suspending said colander over the bottom of a substantially rectangular sink on two adjacent and substantially perpendicular edges of a corner of said sink, and
b. gauging means for measuring a number of servings of an item of food, whereby said colander can be used for straining in a hands-free mode and for determining said number of servings of said item of food.

16. The colander of claim 15, wherein said mounting means includes one or more mounting flanges extending outwardly from one or more sidewalls of said colander in at least two directions which are substantially perpendicular to one another.

17. The colander of claim 15, wherein said gauging means includes one or more serving indicators located on one or more sidewalls signifying suggested serving sizes of said item of food.
